(19) United States
(12) Patent Application Publication
(10) Pub. No.: US 2024/0150865 A1
(43) Pub. Date: May 9, 2024

(54) HYDROMETALLURGICAL METHOD FOR RECOVERING LITHIUM FROM LITHIUM-CONTAINING MINERAL AND LITHIUM AQUEOUS SOLUTION RECOVERED THEREFROM

(71) Applicant: KOREA INSTITUTE OF GEOSCIENCE AND MINERAL RESOURCES, Daejeon (KR)

(72) Inventors: SHUN MYUNG SHIN, Daejeon (KR); SUNGHO JOO, Daejeon (KR); DONGJU SHIN, Daejeon (KR); DONGSEOK LEE, Daejeon (KR)

(21) Appl. No.: 18/501,942

(22) Filed: Nov. 3, 2023

(30) Foreign Application Priority Data
Nov. 7, 2022 (KR) 10-2022-0147137

(51) Int. Cl. C22B 3/04; C22B 1/02; C22B 1/24; C22B 26/12

(52) U.S. Cl. CPC C22B 3/04; C22B 1/02; C22B 1/24; C22B 26/12

(57) ABSTRACT

The present disclosure provides a hydrometallurgical method for recovering lithium from a lithium-containing mineral through calcination and water leaching with a metal oxide without excessive use of chemicals, and a lithium aqueous solution recovered therefrom.

### CROSS-REFERENCE TO RELATED APPLICATIONS

This application claims the priority of Korean Patent Application No. 10-2022-0147137 filed on Nov. 7, 2022, in the Korean Intellectual Property Office, the disclosure of which is incorporated herein by reference.

### BACKGROUND OF THE INVENTION

### Field of the Invention

The present disclosure relates to a hydrometallurgical method for recovering lithium from a lithium-containing mineral through calcination and water leaching with a metal oxide without excessive use of chemicals, and a lithium aqueous solution recovered therefrom.

### Description of the Related Art

Lithium is the lightest metal element, and the industries that utilize lithium (e.g., 74% in batteries, 14% in glass and ceramics, 3% in lubricants, 2% in continuous casting, 2% in polymer production, and 1% in air treatment) are diverse.

In particular, as demand for lithium-ion batteries used in electric vehicles, energy storage systems, and portable electronic products has recently increased rapidly, the battery market has grown significantly.

Accordingly, the demand for lithium compounds, which are key raw materials for cathode materials, cathode materials, and electrolytes of lithium-ion batteries, may be expected to grow explosively.

In order to meet this demand for lithium, lithium production has increased significantly from 28,100 tons in 2010 to 82,500 tons in 2020, and is expected to increase to about 100,000 tons in 2021.

Demand for lithium-ion batteries, which was 244 GWh as of 2021, is expected to grow significantly to 3,254 GWh by 2030, with an average annual growth rate of about 34%. In other words, it is expected that the production of lithium compounds will continue to increase in the future.

Lithium is produced from mineral resources and salt lake resources, and is mostly produced in the form of lithium carbonate. However, mineral resources are concentrated in Australia, and salt lake resources are concentrated in South America, such as Argentina, Bolivia, and Chile. In this way, lithium resources show significant regional bias.

The lithium-containing mineral may be at least one selected from Spodumene (LiAlSi₂O₆), Lepidolite (K(Li,Al)₃(Si,Al)₄O₁₀(F,OH)₂), Zinnwaldite (KLiFeAl(AlSi₃)O₁₀(F,OH)₂)), and Amblygonite (Li,Na)Al(PO₄)(F,OH)).

Among these, the representative lithium mineral is Spodumene, which contains 6 to 9% Li₂O, and commercialized processes for recovering lithium from Spodumene comprise the sulfuric acid method and Australia's SiLeach® process.

In the case of the sulfuric acid method, lithium is extracted from β-spodumene in the form of lithium sulfate using a highly concentrated sulfuric acid solution of 93% or more.

In the case of the SiLeach® process, a mixture of sulfuric acid and hydrofluoric acid is used to leach lithium from α-spodumene.

In order to recover lithium from lithium minerals, a highly concentrated acidic solution is required. Thus, excessive use of chemicals is necessary.

Therefore, the applicant of the present disclosure conducted various studies with great effort and obtained a hydrometallurgical method for recovering lithium from a lithium-containing mineral through calcination and water leaching with a metal oxide without excessive use of chemicals, thereby completing the present disclosure.

### CONTENTS OF THE INVENTION

### Technical Problems

Accordingly, an objective of the present disclosure is to provide a hydrometallurgical method for recovering lithium from a lithium-containing mineral through calcination and water leaching of metal oxides without excessive use of chemicals.

Further, an objective of the present disclosure is to provide a lithium aqueous solution recovered through a hydrometallurgical method for recovering lithium from a lithium-containing mineral through calcination and water leaching with a metal oxide without excessive use of chemicals.

The objectives of the present disclosure are not limited to the objects described above and other objectives will be clearly understood by those skilled in the art from the following description.

### Means of Solving Problem

In order to achieve the objectives, according to an aspect of the present disclosure, there is provided a hydrometallurgical method for recovering lithium from a lithium-containing mineral through calcination and water leaching with an oxide of an alkali metal or alkaline earth metal, comprising the steps of: (a-1) crushing and pulverizing a lithium-containing mineral; (a-2) heat-treating the crushed and pulverized lithium-containing mineral; (a-3) mixing the heat-treated lithium-containing mineral with an oxide of an alkali metal or alkaline earth metal, water leaching the mixture, followed by solid-liquid separation into a primary lithium water leachate and a primary leach residue; (a-4) calcining the primary leach residue; (a-5) water leaching the calcined primary leach residue, followed by solid-liquid separation into a secondary lithium water leachate and a secondary leach residue; and (a-6) recovering lithium from the primary lithium water leachate or the secondary lithium water leachate.

According to one embodiment of the present disclosure, in step (a-1) of crushing and pulverizing a lithium-containing mineral, the lithium-containing mineral is crushed and pulverized using one or more equipment selected from the group consisting of Jaw Crusher, Gyratory Crusher, roller Crusher, Cone Crusher, Hammermil Crusher, Tumbling Mill, Vibration Mill, Attrition Mill, Ball Mill, Rod Mill, Pebble Mill, and Autogeneous Mill, to produce a crushed and pulverized lithium-containing mineral, and the particle size of the crushed and pulverized lithium-containing mineral may be 5 to 300 μm.

According to one embodiment of the present disclosure, the lithium-containing mineral may be at least one selected from Spodumene (LiAlSi₂O₆), Lepidolite (K(Li,Al)₃(Si,Al)₄O₁₀(F,OH)₂), Zinnwaldite (KLiFeAl(AlSi₃)O₁₀(F,OH)₂)), and Amblygonite (Li,Na)Al(PO₄)(F,OH)).

According to one embodiment of the present disclosure, in step (a-2) of heat-treating the crushed and pulverized lithium-containing mineral, the heat-treatment is carried out at a temperature of from 500 to 1000° C., for 10 minutes to 6 hours, and under the gas condition of inputting at least one selected from nitrogen, argon, and air, and the pressure condition of using an atmospheric pressure, and, when the lithium-containing mineral is Spodumene (LiAlSi₂O₆), step (a-2) may further comprise the step of heat-treating the lithium-containing mineral for phase-transition from α-phase to β-phase.

According to one embodiment of the present disclosure, in step (a-3) of mixing the heat-treated lithium-containing mineral with an oxide of an alkali metal or alkaline earth metal, water leaching the mixture, followed by solid-liquid separation into a primary lithium water leachate and a primary leach residue, the type of the oxide of the alkali metal or alkaline earth metal may be at least one selected from calcium oxide (CaO), magnesium oxide (MgO), potassium oxide (K₂O), and sodium oxide (Na₂O).

According to one embodiment of the present disclosure, in step (a-3) of mixing the heat-treated lithium-containing mineral with an oxide of an alkali metal or alkaline earth metal, water leaching the mixture, followed by solid-liquid separation into a primary lithium water leachate and a primary leach residue, the water leaching may be performed by adding to water a mixture of the phase-transitioned lithium-containing mineral (A) and a metal oxide (B) such that the mixing ratio is 1 to 6 in mass ratio (B/A), and at a temperature of 25 to 100° C., in a solid-liquid ratio of 1/20 to 1/5, and for a reaction time of 0.5 to 12 hours.

According to one embodiment of the present disclosure, the lithium leaching rate of the primary lithium water leachate may be 1 to 35 wt %.

According to one embodiment of the present disclosure, in step (a-4) of calcining the primary leach residue, the leach residue is heat-treated under the calcination process condition that the temperature is higher than the temperature at which the Gibbs free energy of the calcination reaction becomes 0, and the heat-treatment temperature for the calcination reaction may be 500 to 1000° C.

According to one embodiment of the present disclosure, in step (a-5) of water leaching the calcined primary leach residue, followed by solid-liquid separation into a secondary lithium water leachate and a secondary leach residue, the water leaching may be performed by adding the calcined primary leach residue to water, and at a temperature of 25 to 100° C., in a solid-liquid ratio of 1/20 to 1/5, and for a reaction time of 0.5 to 12 hours.

According to one embodiment of the present disclosure, step (a-5) of water leaching the calcined primary leach residue, followed by solid-liquid separation into a secondary lithium water leachate and a secondary leach residue, may further comprise the step of: (a-7) calcining the secondary leach residue, wherein the heat-treatment temperature for the calcination reaction may be 500 to 1000° C.

According to one embodiment of the present disclosure, step (a-7) of calcining the secondary leach residue may further comprise the step of: (a-8) water leaching the calcined secondary leach residue, followed by solid-liquid separation into a tertiary lithium water leachate and a tertiary leach residue, wherein the water leaching may be performed by adding the calcined secondary leach residue to water, and at a temperature of 25 to 100° C., in a solid-liquid ratio of 1/20 to 1/5, and for a reaction time of 0.5 to 12 hours.

According to one embodiment of the present disclosure, step (a-8) of water leaching the calcined secondary leach residue, followed by solid-liquid separation into a tertiary lithium water leachate and a tertiary leach residue, may further comprise the step of: (a-9) calcining the tertiary leach residue, wherein the heat-treatment temperature for the calcination reaction may be 500 to 1000° C.

According to one embodiment of the present disclosure, step (a-9) of calcining the tertiary leach residue may further comprise the step of: (a-10) water leaching the calcined tertiary leach residue, followed by solid-liquid separation into a quaternary lithium water leachate and a quaternary leach residue, wherein the water leaching may be performed by adding the calcined tertiary leach residue to water, and at a temperature of to 100° C., in a solid-liquid ratio of 1/20 to 1/5, and for a reaction time of 0.5 to 12 hours.

Further, according to another aspect of the present disclosure, there is provided a lithium aqueous solution recovered by the hydrometallurgical method for recovering lithium from the lithium-containing minerals.

### Effect of the Invention

According to the present disclosure, there is provided a hydrometallurgical method for recovering lithium from a lithium-containing mineral through calcination and water leaching with a metal oxide without excessive use of chemicals, which reduces chemical waste disposal costs and lithium recovery costs.

Further, the present disclosure provides a lithium aqueous solution for industrial application recovered by the hydrometallurgical method for recovering lithium from the lithium-containing minerals, and, thus, the scope of application thereof is wide.

The effects of the present disclosure are not limited thereto and it should be understood that the effects include all effects that can be inferred from the configuration of the present disclosure described in the following specification or claims.

### BRIEF DESCRIPTION OF THE DRAWINGS

FIG. 1 is a process flow chart of a hydrometallurgical method for recovering lithium from a lithium-containing mineral according to an embodiment of the present disclosure.

FIG. 2 is a cumulative particle size distribution chart obtained through particle size analysis of Spodumene according to an embodiment of the present disclosure.

FIG. 3 shows the results of XRD analysis before and after heat-treatment of a Spodumene sample according to an embodiment of the present disclosure.

FIG. 4 shows the results of XRD analysis of the leach residue obtained after water leaching of the CaO/Spodumene mixture according to an embodiment of the present disclosure.

FIG. 5 shows the results of XRD analysis of the calcined product after calcining the water leach residue at 900° C. for 6 hours according to an embodiment of the present disclosure.

FIG. 6 shows the results of XRD analysis of the leach residue obtained after the quaternary water leaching according to an embodiment of the present disclosure.

### DETAILED DESCRIPTION OF THE EMBODIMENTS

Hereinafter, preferred embodiments of the present disclosure will be described with reference to accompanying drawings.

The advantages and features of the present disclosure, and methods of achieving them will be clear by referring to the exemplary embodiments that will be described hereafter in detail with reference to the accompanying drawings.

However, the present disclosure is not limited to the exemplary embodiments described hereafter and may be implemented in various ways, and the exemplary embodiments are provided to complete the description of the present disclosure and let those skilled in the art completely know the scope of the present disclosure and the present disclosure is defined by claims.

Further, when it is determined that well-known technologies, etc. may make the scope of the present disclosure unclear, they will not be described in detail in the following description.

Hereinafter, the present disclosure is described in detail.

Hydrometallurgical Method for Recovering Lithium from a Lithium-Containing Mineral

The present disclosure provide a hydrometallurgical method for recovering lithium from a lithium-containing mineral through calcination and water leaching with a metal oxide without excessive use of chemicals.

The hydrometallurgical method for recovering lithium from a lithium-containing mineral through calcination and water leaching with an oxide of an alkali metal or alkaline earth metal of the present disclosure comprises the steps of: (a-1) crushing and pulverizing a lithium-containing mineral; (a-2) heat-treating the crushed and pulverized lithium-containing mineral; (a-3) mixing the heat-treated lithium-containing mineral with an oxide of an alkali metal or alkaline earth metal, water leaching the mixture, followed by solid-liquid separation into a primary lithium water leachate and a primary leach residue; (a-4) calcining the primary leach residue; (a-5) water leaching the calcined primary leach residue, followed by solid-liquid separation into a secondary lithium water leachate and a secondary leach residue; and (a-6) recovering lithium from the primary lithium water leachate or the secondary lithium water leachate.

The present disclosure provides a hydrometallurgical method for recovering lithium from a lithium-containing mineral through calcination and water leaching with a metal oxide without excessive use of chemicals, which reduces chemical waste disposal costs and lithium recovery costs.

Lithium is the lightest metal element, and the industries that utilize lithium (e.g., 74% in batteries, 14% in glass and ceramics, 3% in lubricants, 2% in continuous casting, 2% in polymer production, and 1% in air treatment) are diverse.

In particular, as demand for lithium-ion batteries used in electric vehicles, energy storage systems, and portable electronic products has recently increased rapidly, the battery market has grown significantly.

Accordingly, the demand for lithium compounds, which are key raw materials for cathode materials, cathode materials, and electrolytes of lithium-ion batteries, may be expected to grow explosively.

In order to meet this demand for lithium, lithium production has increased significantly from 28,100 tons in 2010 to 82,500 tons in 2020, and is expected to increase to about 100,000 tons in 2021.

Demand for lithium-ion batteries, which was 244 GWh as of 2021, is expected to grow significantly to 3,254 GWh by 2030, with an average annual growth rate of about 34%. In other words, it is expected that the production of lithium compounds will continue to increase in the future.

Lithium is produced from mineral resources and salt lake resources, and is mostly produced in the form of lithium carbonate. However, mineral resources are concentrated in Australia, and salt lake resources are concentrated in South America, such as Argentina, Bolivia, and Chile. In this way, lithium resources show significant regional bias.

A lithium-containing mineral comprises at least one selected from Spodumene (LiAlSi₂O₆), Lepidolite (K(Li,Al)₃(Si,Al)₄O₁₀(F,OH)₂), Zinnwaldite (KLiFeAl(AlSi₃)O₁₀(F,OH)₂)), and Amblygonite (Li,Na)Al(PO₄)(F,OH)).

Among these, the representative lithium mineral is Spodumene, which contains 6 to 9% Li₂O, and commercialized processes for recovering lithium from Spodumene comprise the sulfuric acid method and Australia's SiLeach® process.

In the case of the sulfuric acid method, lithium is extracted from β-spodumene in the form of lithium sulfate using a highly concentrated sulfuric acid solution of 93% or more.

In the case of the SiLeach® process, a mixture of sulfuric acid and hydrofluoric acid is used to leach lithium from α-spodumene.

In order to recover lithium from lithium minerals, a highly concentrated acidic solution is required. Thus, excessive use of chemicals is necessary.

Therefore, the applicant of the present disclosure conducted various studies with great effort and obtained a hydrometallurgical method for recovering lithium from a lithium-containing mineral through calcination and water leaching with a metal oxide without excessive use of chemicals, thereby completing the present disclosure.

Here, in step (a-1) of crushing and pulverizing a lithium-containing mineral, the lithium-containing mineral is crushed and pulverized using one or more equipment selected from the group consisting of Jaw Crusher, Gyratory Crusher, roller Crusher, Cone Crusher, Hammermil Crusher, Tumbling Mill, Vibration Mill, Attrition Mill, Ball Mill, Rod Mill, Pebble Mill, and Autogeneous Mill, to produce a crushed and pulverized lithium-containing mineral, and the particle size of the crushed and pulverized lithium-containing mineral may be 5 to 300 μm.

At this time, the particle size of the crushed and pulverized lithium-containing mineral may preferably be 5 to 298 μm, and more preferably 5 to 295 μm.

Further, the lithium-containing mineral may be at least one selected from Spodumene (LiAlSi₂O₆), Lepidolite (K(Li,Al)₃(Si,Al)₄O₁₀(F,OH)₂), Zinnwaldite (KLiFeAl(AlSi₃)O₁₀(F,OH)₂)), and Amblygonite (Li,Na)Al(PO₄)(F,OH)).

Further, in step (a-2) of heat-treating the crushed and pulverized lithium-containing mineral, the heat-treatment is carried out at a temperature of from 500 to 1000° C., for 10 minutes to 6 hours, and under the gas condition of inputting at least one selected from nitrogen, argon, and air, and the pressure condition of using an atmospheric pressure, and when the lithium-containing mineral is Spodumene (LiAlSi₂O₆), step (a-2) may further comprise the step of heat-treating the lithium-containing mineral for phase-transition from α-phase to β-phase.

Here, if the heat-treatment conditions are outside the above-described range, there may be disadvantages that heat-treatment efficiency decreases and the process is not economical.

At this time, the heat-treatment temperature may be preferably 500 to 980° C., and more preferably 500 to 950° C.

Further, the heat-treatment time may preferably be 10 minutes to 5.8 hours, and more preferably 10 minutes to 5.5 hours.

Here, in step (a-3) of mixing the heat-treated lithium-containing mineral with an oxide of an alkali metal or alkaline earth metal, water leaching the mixture, followed by solid-liquid separation into a primary lithium water leachate and a primary leach residue, the type of the oxide of the alkali metal or alkaline earth metal may be at least one selected from calcium oxide (CaO), magnesium oxide (MgO), potassium oxide (K₂O), and sodium oxide (Na₂O).

Further, in step (a-3) of mixing the heat-treated lithium-containing mineral with an oxide of an alkali metal or alkaline earth metal, water leaching the mixture, followed by solid-liquid separation into a primary lithium water leachate and a primary leach residue, the water leaching may be performed by adding to water a mixture of the phase-transitioned lithium-containing mineral (A) and a metal oxide (B) such that the mixing ratio is 1 to 6 in mass ratio (B/A), and at a temperature of 25 to 100° C., in a solid-liquid ratio of 1/20 to 1/5, and for a reaction time of 0.5 to 12 hours.

Here, if the mixing ratio of the mixture of the phase-transitioned lithium-containing mineral (A) and the metal oxide (B) is outside the above-described range, there may be disadvantages that water leaching efficiency decreases and the process is not economical.

At this time, the mixing ratio of the mixture of the phase-transitioned lithium-containing mineral (A) and the metal oxide (B) may preferably be 1 to 5.8 in mass ratio (B/A), and more preferably 1 to 5.5 in mass ratio (B/A).

Further, if the reaction temperature during water leaching is outside the above-described range, there may be disadvantages that water leaching efficiency decreases and the process is not economical.

At this time, the reaction temperature during the water leaching may be preferably 25 to 98° C., and more preferably 25 to 95° C.

Further, if the solid-liquid ratio during the water leaching is outside the above-described range, there may be disadvantages that water leaching efficiency decreases and the process is not economical.

At this time, the solid-liquid ratio during the water leaching may be preferably 1/20 to 1/8, and more preferably 1/15 to 1/8.

Further, if the reaction time during the water leaching is outside the above-described range, there may be disadvantages that water leaching efficiency decreases and the process is not economical.

At this time, the reaction time during the water leaching may be preferably 0.5 to 11.5 hours, and more preferably 0.5 to 11 hours.

Further, the lithium leaching rate of the primary lithium water leachate may be 1 to 35 wt %.

Further, in step (a-4) of calcining the primary leach residue, the leach residue is heat-treated under the calcination process condition that the temperature is higher than the temperature at which the Gibbs free energy of the calcination reaction becomes 0, and the heat-treatment temperature for the calcination reaction may be 500 to 1000° C.

Here, if the heat-treatment temperature for the calcination reaction is outside the above-described range, there may be disadvantages that the calcination reaction efficiency decreases and the process is not economical.

At this time, the heat-treatment temperature for the calcination reaction may be preferably 600 to 980° C., and more preferably 600 to 950° C.

Further, in step (a-5) of water leaching the calcined primary leach residue, followed by solid-liquid separation into a secondary lithium water leachate and a secondary leach residue, the water leaching may be performed by adding the calcined primary leach residue to water, and at a temperature of 25 to 100° C., in a solid-liquid ratio of 1/20 to 1/5, and for a reaction time of 0.5 to 12 hours.

Here, if the reaction temperature during the water leaching of the calcined primary leach residue is outside the above-described range, there may be disadvantages that water leaching efficiency decreases and the process is not economical.

At this time, the reaction temperature during the water leaching of the calcined primary leach residue may be preferably 25 to 98° C., and more preferably 25 to 95° C.

Further, if the solid-liquid ratio during the water leaching of the calcined primary leach residue is outside the above-described range, there may be disadvantages that water leaching efficiency decreases and the process is not economical.

At this time, the solid-liquid ratio during the water leaching of the calcined primary leach residue may be preferably 1/20 to 1/8, and more preferably 1/15 to 1/8.

Further, if the reaction time during the water leaching of the calcined primary leach residue is outside the above-described range, there may be disadvantages that water leaching efficiency decreases and the process is not economical.

At this time, the reaction time during the water leaching of the calcined primary leach residue may be preferably 0.5 to 11.5 hours, and more preferably 0.5 to 11 hours.

Further, step (a-5) of water leaching the calcined primary leach residue, followed by solid-liquid separation into a secondary lithium water leachate and a secondary leach residue, may further comprise the step of: (a-7) calcining the secondary leach residue, wherein the heat-treatment temperature for the calcination reaction may be 500 to 1000° C.

Here, if the heat-treatment temperature for the calcination reaction is outside the above-described range, there may be disadvantages that calcination reaction efficiency decreases and the process is not economical.

At this time, the heat-treatment temperature for the calcination reaction may be preferably 600 to 980° C., and more preferably 600 to 950° C.

Further, step (a-7) of calcining the secondary leach residue may further comprise the step (a-8) of water leaching the calcined secondary leach residue, followed by solid-liquid separation into a tertiary lithium water leachate and a tertiary leach residue, wherein the water leaching may be performed by adding the calcined secondary leach residue to water, and at a temperature of 25 to 100° C., in a solid-liquid ratio of 1/20 to 1/5, and for a reaction time of 0.5 to 12 hours.

Here, if the reaction temperature during the water leaching of the calcined secondary leach residue is outside the above-described range, there may be disadvantages that water leaching efficiency decreases and the process is not economical.

At this time, the reaction temperature during the water leaching of the calcined secondary leach residue may be preferably 25 to 98° C., and more preferably 25 to 95° C.

Further, if the solid-liquid ratio during the water leaching of the calcined secondary leach residue is outside the above-described range, there may be disadvantages that water leaching efficiency decreases and the process is not economical.

At this time, the solid-liquid ratio during the water leaching of the calcined secondary leach residue may be preferably 1/20 to 1/8, and more preferably 1/15 to 1/8.

Further, if the reaction time during the water leaching of the calcined secondary leach residue is outside the above-described range, there may be disadvantages that water leaching efficiency decreases and the process is not economical.

At this time, the reaction time during the water leaching of the calcined secondary leach residue may be preferably 0.5 to 11.5 hours, and more preferably 0.5 to 11 hours.

Further, step (a-8) of water leaching the calcined secondary leach residue, followed by solid-liquid separation into a tertiary lithium water leachate and a tertiary leach residue, may further comprise the step (a-9) of calcining the tertiary leach residue, wherein the heat-treatment temperature for the calcination reaction may be 500 to 1000° C.

Here, if the heat-treatment temperature for the calcination reaction is outside the above-described range, there may be disadvantages that calcination reaction efficiency decreases and the process is not economical.

At this time, the heat-treatment temperature for the calcination reaction may be preferably 600 to 980° C., and more preferably 600 to 950° C.

Further, step (a-9) of calcining the tertiary leach residue may further comprise the step (a-10) of water leaching the calcined tertiary leach residue, followed by solid-liquid separation into a quaternary lithium water leachate and a quaternary leach residue, wherein the water leaching may be performed by adding the calcined tertiary leach residue to water, and at a temperature of 25 to 100° C., in a solid-liquid ratio of 1/20 to 1/5, and for a reaction time of 0.5 to 12 hours.

Here, if the reaction temperature during the water leaching of the calcined tertiary leach residue is outside the above-described range, there may be disadvantages that water leaching efficiency decreases and the process is not economical.

At this time, the reaction temperature during the water leaching of the calcined tertiary leach residue may be preferably 25 to 98° C., and more preferably 25 to 95° C.

Further, if the solid-liquid ratio during the water leaching of the calcined tertiary leach residue is outside the above-described range, there may be disadvantages that water leaching efficiency decreases and the process is not economical.

At this time, the solid-liquid ratio during the water leaching of the calcined tertiary leach residue may be preferably 1/20 to 1/8, and more preferably 1/15 to 1/8.

Further, if the reaction time during the water leaching of the calcined tertiary leach residue is outside the above-described range, there may be disadvantages that water leaching efficiency decreases and the process is not economical.

At this time, the reaction time during the water leaching of the calcined tertiary leach residue may be preferably 0.5 to 11.5 hours, and more preferably 0.5 to 11 hours.

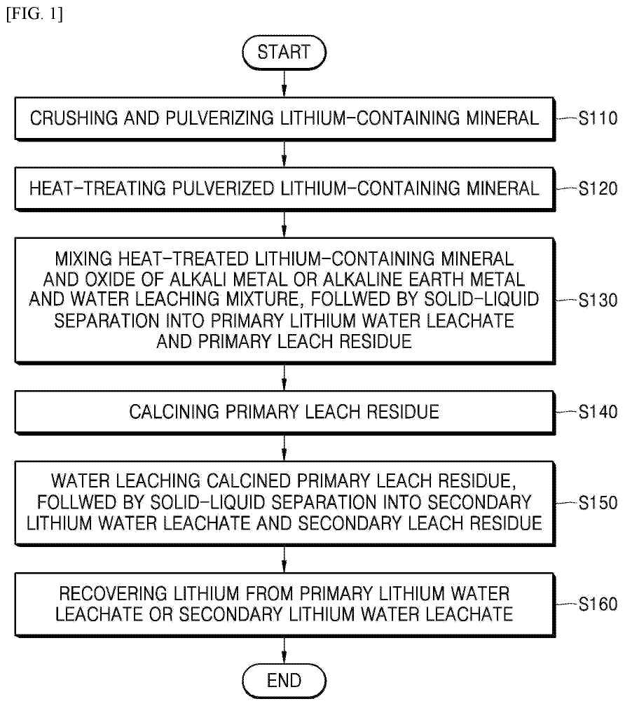

FIG. 1 is a process flow chart of a hydrometallurgical method for recovering lithium from a lithium-containing mineral according to an embodiment of the present disclosure.

Referring to FIG. 1, after a lithium-containing mineral is crushed and pulverized S110, the crushed and pulverized lithium-containing mineral may be heat-treated S120.

Then, the heat-treated lithium-containing mineral and an oxide of an alkali metal or alkaline earth metal may be mixed and water leached, followed by solid-liquid separation into primary lithium water leachate and primary leach residue S130.

Thereafter, the primary leach residue may be calcined S140, and the calcined primary leach residue may be water leached, followed by solid-liquid separation into a secondary lithium water leachate and a secondary leach residue S150.

Then, lithium may be recovered from the primary lithium water leachate or the secondary lithium water leachate S160.

Here, the step of water leaching the calcined primary leach residue, followed by solid-liquid separation into a secondary lithium water leachate and a secondary leach residue, may further comprise the step of calcining the secondary leach residue.

Further, the step of calcining the secondary leach residue may further comprise the step of water leaching the calcined secondary leach residue, followed by solid-liquid separation into a tertiary lithium water leachate and a tertiary leach residue.

Further, the step of water leaching the calcined secondary leach residue, followed by solid-liquid separation into a tertiary lithium water leachate and a tertiary leach residue, may further comprise the step of calcining the tertiary leach residue.

Further, the step of water leaching the calcined tertiary leach residue may further comprise the step of water leaching the calcined tertiary leach residue, followed by solid-liquid separation into a quaternary lithium water leachate and a quaternary leach residue.

Then, lithium may be recovered from the tertiary lithium water leachate or the quaternary lithium water leachate.

Lithium Aqueous Solution Recovered Through a Hydrometallurgical Method for Recovering Lithium from a Lithium-Containing Mineral

The present disclosure provides a lithium aqueous solution for industrial application recovered through a hydrometallurgical method for recovering lithium from a lithium-containing mineral through calcination and water leaching with a metal oxide without excessive use of chemicals.

The present disclosure provides a lithium aqueous solution for industrial application recovered through the hydrometallurgical method for recovering lithium from a lithium-containing mineral.

The present disclosure provides a lithium aqueous solution for industrial application recovered through the hydrometallurgical method for recovering lithium from a lithium-containing mineral through calcination and water leaching with a metal oxide without excessive use of chemicals, and, thus, the scope of application thereof is wide.

Hereafter, preferred embodiments are proposed to help understand the present disclosure, but the following embodiments just exemplify the present disclosure and the scope of the present disclosure is not limited to the following embodiments. The following embodiments may be appropriately modified and changed by those skilled in the art within the scope of the present disclosure.

### EMBODIMENT

### <Embodiment 1> Particle Size Analysis and Phase-Transition of Spodumene

A powder was prepared by crushing and pulverizing Spodumene containing lithium.

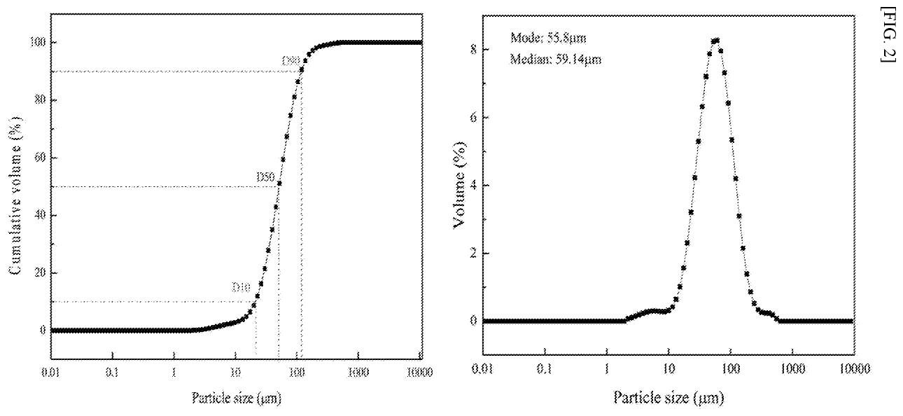

The particle size distribution of Spodumene is shown in FIG. 2 and Table 1 below.

FIG. 2 is a cumulative particle size distribution chart obtained through the particle size analysis of Spodumene according to Embodiment 1.

TABLE 1

| | D10 | D50 | D90 |
|---|---|---|---|
| Spodumene(μm) | 24.306 | 59.14 | 134.751 |

Referring to FIG. 2 and Table 1, the most widely distributed particle size is 55.8 μm, and 10% (D10) of the particle size distribution is 24.306 μm, 50% (D50) is 59.14 μm, and 90% (D90) is 134.751 μm. In other words, it was confirmed that the median particle size of the supplied α-spodumene is 59.14 μm, and more than 90% of the samples have a particle size of 100 mesh (150 μm) or less.

Further, Table 2 below shows the composition of Spodumene used in Embodiment 1.

TABLE 2

| Elements | Li | Si | Al | Ca | Fe | Na | K | Mg |
|---|---|---|---|---|---|---|---|---|
| wt % | 2.35 | 31.7 | 13.4 | 0.2 | 0.1 | 0.32 | 0.33 | 0.02 |

Referring to Table 2, Spodumene contains 2.35 wt % of Li, 31.7 wt % of Si, 13.4 wt % of Al, 0.2 wt % of Ca, 0.1 wt % of Fe, 0.32 wt % of Na, 0.33 wt % of K, and 0.02 wt % of Mg.

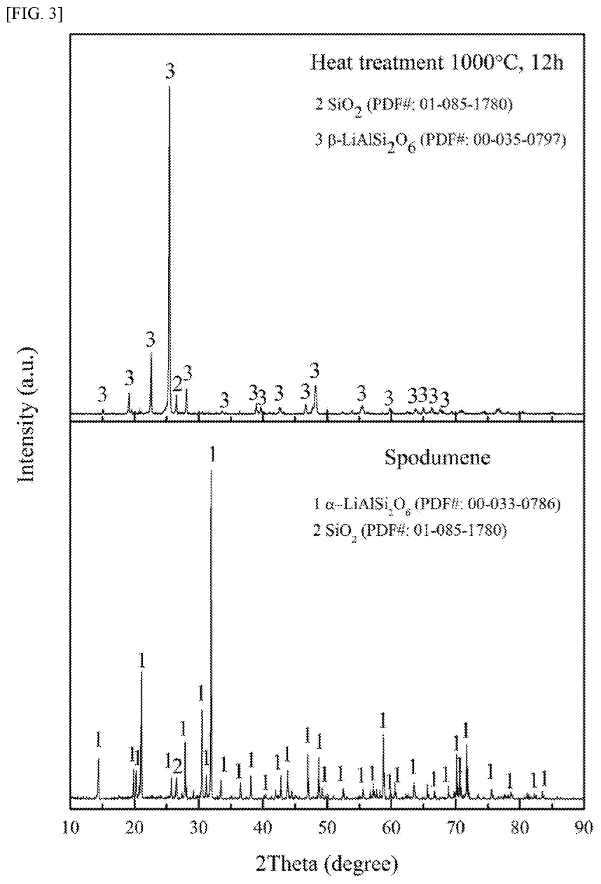

FIG. 3 shows the results of XRD analysis before and after heat-treatment of the Spodumene sample of Embodiment 1.

FIG. 3 shows the XRD analysis results of α-spodumene and β-spodumene formed by heat-treating α-spodumene at 1000° C. for 12 hours, before heat treatment.

Referring to FIG. 3, the XRD analysis results of the Spodumene sample before and after heat-treatment confirmed that the phase was transitioned from α-spodumene to β-spodumene.

### <Embodiment 2> Water Leaching According to Particle Size of Phase-Transitioned Spodumene

Water leaching was performed according to the particle size of Spodumene that had undergone phase-transition to β-spodumene in Embodiment 1.

To determine the leaching tendency of lithium according to the particle size of 3-spodumene, particle size separation was performed based on 100, 200, and 270 mesh, and β-spodumene samples of each particle size were mixed with CaO at a mass ratio of 1:1, and the leaching experiment was performed under the conditions (i.e., in the solid-liquid ratio of 1/10 (30 g/300 mL), at the reaction temperature of 100° C., at the stirring speed of 200 rpm, and for the reaction time of 12 hours). The leaching rate according to a particle size is shown in Table 3 below.

TABLE 3
Leaching rate according to particle size of Spodumene (wt %)

| Particle | | | | | | | | | |
|---|---|---|---|---|---|---|---|---|---|
| size | Li | Ca | Na | K | Fe | Mg | Al | Si | pH |
| 150 μm | 23.7 | 0.1 | 26.5 | 20.8 | 0.0 | 0.0 | 0.4 | 0.01 | 11.2 |
| undersize | | | | | | | | | |
| 75 μm | 29.2 | 0.1 | 40.6 | 41.4 | 0.0 | 0.0 | 0.6 | 0.02 | 11.5 |
| undersize | | | | | | | | | |
| 53 μm | 29.1 | 0.1 | 44.1 | 43.4 | 0.0 | 0.0 | 0.5 | 0.03 | 11.1 |
| undersize | | | | | | | | | |

Referring to Table 3 above, when spodumene of 150 μm undersize was used, 23.7 wt % of Li, 0.1 wt % of Ca, 26.5 wt % of Na, 20.8 wt % of K, 0.4 wt % of Al, and 0.01 wt % of Si were leached. In the case of spodumene of 75 μm undersize, 29.2 wt % of Li, 0.1 wt % of Ca, 40.6 wt % of Na, 41.4 wt % of K, 0.6 wt % of Al, and 0.02 wt % of Si were leached. From spodumene of 53 μm undersize, 29.1 wt % of Li, 0.1 wt % of Ca, 44.1 wt % of Na, 43.4 wt % of K, 0.5 wt % of Al, and 0.03 wt % of Si were leached.

Therefore, it was confirmed that, as the particle size of spodumene decreased, the leaching rate of metal ions also increased, but in the case of lithium, its leaching rates at the particle sizes of spodumene of 75 μm undersize and 53 μm undersize were similar, being about 29 wt %.

### <Embodiment 3> Water Leaching According to Reaction Temperature

After β-spodumene, which had undergone phase-transition in Embodiment 1, was mixed with CaO, the mixture was water leached to evaluate the water leaching results according to a reaction temperature.

A leaching experiment was subjected to β-spodumene of 75 μm undersize according to a reaction temperature, under the conditions (i.e., in the mixing ratio of β-spodumene of 75 μm undersize and CaO of 1:1, in the solid-liquid ratio of 1/10 (30 g/300 mL), at the stirring speed 200 rpm, and for the reaction time of 12 hours). At this time, the reaction temperatures were 25, 50, and 100° C., and the leaching rate according to a reaction temperature is shown in Table 4 below.

TABLE 4
Leaching rate according to reaction temperature (wt %)

| Reaction | | | | | | | | | |
|---|---|---|---|---|---|---|---|---|---|
| temperature | Li | Ca | Na | K | Fe | Mg | Al | Si | pH |
| 25° C. | 0.45 | 2.1 | 2.6 | 7.2 | 0 | 0 | 0 | 0.001 | 10.8 |
| 50° C. | 4.0 | 1.2 | 8.1 | 10.8 | 0 | 0 | 0.16 | 0.001 | 11.0 |
| 100° C. | 29.5 | 0.05 | 40.6 | 42.9 | 0 | 0 | 0.55 | 0.02 | 10.9 |

Referring to Table 4 above, when the reaction temperature was 25° C., 0.45 wt % of Li, 2.1 wt % of Ca, 2.6 wt % of Na, 7.2 wt % of K, and 0.001 wt % of Si were leached. At 50° C., 4.0 wt % of Li, 1.2 wt % of Ca, 8.1 wt % of Na, 10.8 wt % of K, 0.16 wt % of Al, and 0.001 wt % of Si were leached. At 100° C., 29.5 wt % of Li, 0.05 wt % of Ca, 40.6 wt % of Na, 42.9 wt % of K, 0.55 wt % of Al, and 0.02 wt % of Si were leached. In other words, it was confirmed that, as the reaction temperature increased, the lithium leaching rate rapidly increased.

### <Embodiment 4> Water Leaching According to Reaction Time

After β-spodumene, which had undergone phase-transition in Embodiment 1, was mixed with CaO, the mixture was water leached to evaluate the water leaching results according to a reaction time.

A leaching experiment was subjected to β-spodumene of 75 μm undersize according to a reaction time, under the conditions (i.e., in the mixing ratio of β-spodumene of 75 μm undersize and CaO of 1:1, in the solid-liquid ratio of 1/10 (30 g/300 mL), at the reaction temperature of 100° C. and at the stirring speed 200 rpm). At this time, the reaction times were 1, 2, 4, 6, 9, 10, and 12 hours, and the leaching rate according to a reaction time is shown in Table 5 below.

TABLE 5
Leaching rate according to reaction time (wt %)

| Time (hr) | Li | Ca | Na | K | Fe | Mg | Al | Si | pH |
|---|---|---|---|---|---|---|---|---|---|
| 1 | 7.6 | 0.8 | 24.6 | 13.9 | 0 | 0 | 0.3 | 0.01 | 10.8 |
| 2 | 13.0 | 0.3 | 23.4 | 17.0 | 0 | 0 | 0.4 | 0.01 | 10.9 |
| 4 | 24.9 | 0.1 | 38.8 | 19.4 | 0 | 0 | 0.5 | 0.01 | 11.1 |
| 6 | 30.0 | 0.1 | 42.5 | 39.0 | 0 | 0 | 0.6 | 0.02 | 11.0 |
| 9 | 32.5 | 0.1 | 46.3 | 37.5 | 0 | 0 | 0.6 | 0.02 | 11.2 |
| 10 | 33.4 | 0.1 | 52.3 | 38.3 | 0 | 0 | 0.6 | 0.02 | 10.9 |
| 12 | 32.6 | 0.1 | 51.0 | 38.4 | 0 | 0 | 0.7 | 0.02 | 11.1 |

Referring to Table 5, it was confirmed that the leaching rate of Li increased as the reaction time passed, and the leaching rate was maintained at about 33 wt % after 9 hours. In the case of Ca, the leaching rate was about 0.8 wt % after 1 hour, but decreased to about 0.1 wt % after 4 hours. In the cases of Na, K, Al, and Si, the leaching rates increased with time, and, after 12 hours, the leaching rates were 51 wt %, 38.4 wt %, 0.7 wt %, and 0.02 wt %, respectively. Besides, Fe and Mg were not leached.

### <Embodiment 5> Water Leaching According to Mass Ratio of CaO and β-Spodumene

After β-spodumene, which had undergone phase-transition in Embodiment 1, was mixed with CaO, the mixture was water leached to evaluate the water leaching results according to a mass ratio of CaO and β-spodumene.

A leaching experiment was subjected to β-spodumene of 75 μm undersize according to a mass ratio of CaO and β-spodumene, under the conditions (i.e., in the mixing ratio of -spodumene of 75 μm undersize and CaO of 1:1, in the solid-liquid ratio of 1/10 (30 g/300 mL), at the reaction temperature of 100° C., at the stirring speed of 200 rpm and for the reaction time of 9 hours). At this time, the mass ratio of CaO and β-spodumene (CaO/β-spodumene) were 1, 2, 3 and 4, and the leaching rate according to a mass ratio of CaO and β-spodumene is shown in Table 6 below.

TABLE 6
Leaching rate according to mass ratio of CaO/β-spodumene (wt %)

| Mass | | | | | | | | | |
|---|---|---|---|---|---|---|---|---|---|
| ratio | Li | Ca | Na | K | Fe | Mg | Al | Si | pH |
| 1 | 31.7 | 0.1 | 33.7 | 25.2 | 0 | 0 | 0.6 | 0.02 | 10.8 |
| 2 | 38.2 | 0.1 | 47.6 | 39.4 | 0 | 0 | 0.5 | 0.02 | 11.2 |
| 3 | 39.2 | 0.1 | 51.8 | 42.9 | 0 | 0 | 0.5 | 0.02 | 11.4 |
| 4 | 39.1 | 0.1 | 54.3 | 47.3 | 0 | 0 | 0.5 | 0.01 | 11.5 |

Referring to Table 6 above, when the ratio of CaO/β-spodumene was 1, 31.7 wt % of Li, 0.1 wt % of Ca, 33.7 wt % of Na, 25.2 wt % of K, 0.6 wt % of Al, and 0.02 wt % of Si were leached. When the ratio of CaO/β-spodumene was 2, 38.2 wt % of Li, 0.1 wt % of Ca, 47.6 wt % of Na, 39.4 wt % of K, 0.5 wt % of Al, and 0.02 wt % of Si were leached. When the ratio of CaO/β-spodumene was 3, 39.2 wt % of Li, 0.1 wt % of Ca, 51.8 wt % of Na, 42.9 wt % of K, 0.5 wt % of Al, and 0.02 wt % of Si were leached. When the ratio of CaO/β-spodumene was 4, 39.1 wt % of Li, 0.1 wt % of Ca, 54.3 wt % of Na, 47.3 wt % of K, 0.5 wt % of Al, and 0.01 wt % of Si were leached.

Therefore, it was confirmed that, when the ratio of CaO/β-spodumene was 1 or more, the leaching rate of Li increased significantly.

### <Embodiment 6> Calcination of Water Leach Residue

After β-spodumene, which had undergone phase-transition in Embodiment 1, was mixed with CaO, the mixture was water leached to separate the water leach residue, and calcination was performed thereon.

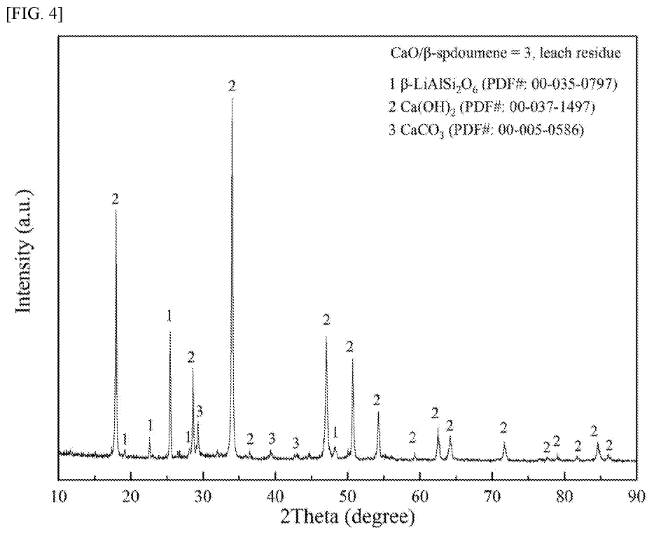

The XRD analysis results of the leach residue obtained after water leaching of 75 μm undersize β-spodumene under the conditions (i.e., in the mass ratio of CaO/β-spodumene of 3, in the solid-liquid ratio of 1/10 (30 g/300 mL), at the stirring speed of 200 rpm, and for the reaction temperature of 100° C.) for 9 hours are shown in FIG. 4.

FIG. 4 shows the results of XRD analysis of the leach residue obtained after water leaching of the CaO/Spodumene mixture according to Embodiment 6.

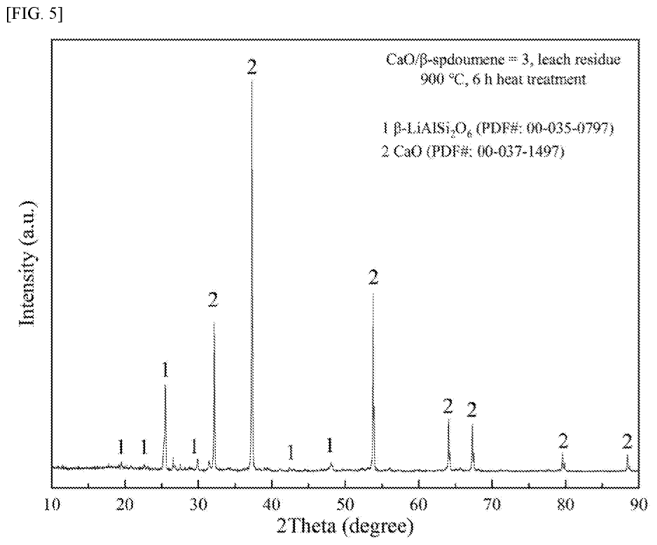

Referring to FIG. 4, unreacted β-spodumene, Ca(OH)₂, and CaCO₃ were observed in the leach residue obtained after water leaching. Heat-treatment was performed at 900° C. for 6 hours to convert Ca(OH)₂ and CaCO₃ present in the leach residue back into CaO. The results of XRD analysis of the calcined product at that time are shown in FIG. 5.

FIG. 5 shows the results of XRD analysis of the calcined product after calcining the water leach residue at 900° C. for 6 hours according to Embodiment 6.

Referring to FIG. 5, it was confirmed that both Ca(OH)₂ and CaCO₃ were converted to CaO. The calcined product was again subjected to water leaching under conditions (i.e., in the solid-liquid ratio of 1/10, at the reaction temperature of 100° C., at the stirring speed of 200 rpm, and for the reaction time of 9 hours) to additionally leach lithium, and these water leaching and calcination processes were repeated to continue leaching lithium.

### <Embodiment 7> Continuous Calcination and Water Leaching

After β-spodumene, which had undergone phase-transition in Embodiment 1, was mixed with CaO, the mixture was water leached to separate the water leach residue, and continuous calcination and water leaching were performed thereon.

After performing water leaching of 75 μm undersize β-spodumene for 9 hours under the conditions (i.e., in the mass ratio of CaO/β-spodumene of 3, in the solid-liquid ratio of 1/10 (30 g/300 mL), at the stirring speed of 200 rpm, and at the reaction temperature of 100° C.), the water leach residue obtained was subjected to continuous calcination and water leaching. The leaching rates obtained by performing water leaching four times in succession are shown in Table 7 below.

TABLE 7
Leaching rate per batch of continuous water leaching (wt %)

| Mass | | | | | | | | | |
|---|---|---|---|---|---|---|---|---|---|
| ratio | Li | Ca | Na | K | Fe | Mg | Al | Si | pH |
| 1 | 38.9 | 0.1 | 51.8 | 42.9 | 0 | 0 | 0.7 | 0.01 | 11.1 |
| 2 | 31.7 | 0.2 | 26.1 | 17.2 | 0 | 0 | 0.6 | 0.02 | 11.2 |
| 3 | 18.5 | 0.3 | 9.8 | 13.7 | 0 | 0 | 0.6 | 0.01 | 11.0 |
| 4 | 8.1 | 0.2 | 7.0 | 9.0 | 0 | 0 | 0.3 | 0.01 | 11.4 |
| Total | 97.2 | 0.9 | 94.7 | 82.8 | 0 | 0 | 2.2 | 0.05 | — |

Referring to Table 7 above, when the 1st, 2nd, 3rd, and 4th water leaching was performed, 38.9 wt %, 31.7 wt %, 18.5 wt %, and 8.1 wt % of lithium were leached, respectively, and, finally, a total of 97.2 wt % of lithium could be leached from spodumene. At this time, 0.9 wt % of Ca, 94.7 wt % of Na, 82.8 wt % of K, 2.2 wt % of Al, and 0.05 wt % of Si were leached together, and no leaching of Fe and Mg occurred. When all leachates obtained from each water leaching experiment were mixed, 197.2 mg/L of Li, 155.3 mg/L of Ca, 31.9 mg/L of Na, 29.3 mg/L of K, 22.2 mg/L of Al, and 1.5 mg/L of Si was analyzed.

In view of the mass balance of lithium in each water leaching, 70.4, 57.3, 33.4, and 14.6 mg of lithium were leached from spodumene, which contains a total of 180.6 mg of lithium, through the 1st, 2nd, 3rd, and 4th water leaching, respectively, such that a total of 175.7 mg Li (97.2 wt %) of lithium was leached.

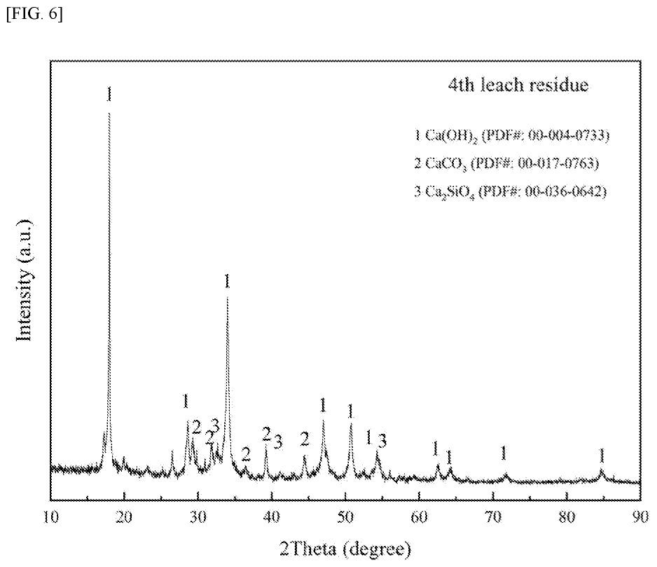

And, the XRD analysis results of the leach residue obtained after the 4th water leaching are shown in FIG. 6.

FIG. 6 shows the results of XRD analysis of the leach residue obtained after the quaternary water leaching according to Embodiment 7.

Referring to FIG. 6, the leach residue obtained after the 4th water leaching consists of Ca(OH)₂, CaCO₃, and Ca₂SiO₄. It is considered that the leach residue may also be reused in the leaching process if converted to CaO through a calcination process at 900° C.

Embodiments about a hydrometallurgical method for recovering lithium from a lithium-containing mineral and a lithium aqueous solution recovered therefrom according to the present disclosure were described above, but it is apparent that various modifications may be achieved without departing from the scope of the present disclosure.

Therefore, the scope of the present disclosure should not be limited to the embodiment(s) and should be determined by not only the following claims, but equivalents of the claims.

That is, it should be understood that the embodiments described above are not limitative, but only examples in all respects, the scope of the present disclosure is expressed by claims described below, not the detailed description, and it should be construed that all of changes and modifications achieved from the meanings and scope of claims and equivalent concept are included in the scope of the present disclosure.

What is claimed is:

1. A hydrometallurgical method for recovering lithium from a lithium-containing mineral through calcination and water leaching with an oxide of an alkali metal or alkaline earth metal, comprising the steps of:
(a-1) crushing and pulverizing a lithium-containing mineral;
(a-2) heat-treating the crushed and pulverized lithium-containing mineral;
(a-3) mixing the heat-treated lithium-containing mineral with an oxide of an alkali metal or alkaline earth metal, water leaching the mixture, followed by solid-liquid separation into a primary lithium water leachate and a primary leach residue;
(a-4) calcining the primary leach residue;
(a-5) water leaching the calcined primary leach residue, followed by solid-liquid separation into a secondary lithium water leachate and a secondary leach residue; and
(a-6) recovering lithium from the primary lithium water leachate or the secondary lithium water leachate.

2. The hydrometallurgical method for recovering lithium from a lithium-containing mineral according to claim 1, which is characterized in that:
in step (a-1) of crushing and pulverizing a lithium-containing mineral,
the lithium-containing mineral is crushed and pulverized using one or more equipment selected from the group consisting of Jaw Crusher, Gyratory Crusher, roller Crusher, Cone Crusher, Hammermil Crusher, Tumbling Mill, Vibration Mill, Attrition Mill, Ball Mill, Rod Mill, Pebble Mill, and Autogeneous Mill, to produce a crushed and pulverized lithium-containing mineral, and
the particle size of the crushed and pulverized lithium-containing mineral is 5 to 300 μm.

3. The hydrometallurgical method for recovering lithium from a lithium-containing mineral according to claim 1, which is characterized in that:
the lithium-containing mineral is at least one selected from Spodumene (LiAlSi₂O₆), Lepidolite (K(Li,Al)₃(Si,Al)₄O₁₀(F,OH)₂), Zinnwaldite (KLiFeAl(AlSi₃)O₁₀(F,OH)₂)), and Amblygonite (Li,Na)Al(PO₄)(F,OH)).

4. The hydrometallurgical method for recovering lithium from a lithium-containing mineral according to claim 1, which is characterized in that:
in step (a-2) of heat-treating the crushed and pulverized lithium-containing mineral,
the heat-treatment is carried out at a temperature of from 500 to 1000° C., for 10 minutes to 6 hours, and under the gas condition of inputting at least one selected from nitrogen, argon, and air, and the pressure condition of using an atmospheric pressure, and
when the lithium-containing mineral is Spodumene (LiAlSi₂O₆),
step (a-2) further comprises the step of heat-treating the lithium-containing mineral for phase-transition from α-phase to β-phase.

5. The hydrometallurgical method for recovering lithium from a lithium-containing mineral according to claim 1, which is characterized in that:
in step (a-3) of mixing the heat-treated lithium-containing mineral with an oxide of an alkali metal or alkaline earth metal, water leaching the mixture, followed by solid-liquid separation into a primary lithium water leachate and a primary leach residue,
the type of the oxide of the alkali metal or alkaline earth metal is at least one selected from calcium oxide (CaO), magnesium oxide (MgO), potassium oxide (K₂O), and sodium oxide (Na₂O).

6. The hydrometallurgical method for recovering lithium from a lithium-containing mineral according to claim 1, which is characterized in that:
in step (a-3) of mixing the heat-treated lithium-containing mineral with an oxide of an alkali metal or alkaline earth metal, water leaching the mixture, followed by solid-liquid separation into a primary lithium water leachate and a primary leach residue,
the water leaching is performed by adding to water a mixture of the phase-transitioned lithium-containing mineral (A) and a metal oxide (B) such that the mixing ratio is 1 to 6 in mass ratio (B/A), and
at a temperature of 25 to 100° C., in a solid-liquid ratio of 1/20 to 1/5, and for a reaction time of 0.5 to 12 hours.

7. The hydrometallurgical method for recovering lithium from a lithium-containing mineral according to claim 1, which is characterized in that:
the lithium leaching rate of the primary lithium water leachate is 1 to 35 wt %.

8. The hydrometallurgical method for recovering lithium from a lithium-containing mineral according to claim 1, which is characterized in that:
in step (a-4) of calcining the primary leach residue,
the leach residue is heat-treated under the calcination process condition that the temperature is higher than the temperature at which the Gibbs free energy of the calcination reaction becomes 0, and
the heat-treatment temperature for the calcination reaction is 500 to 1000° C.

9. The hydrometallurgical method for recovering lithium from a lithium-containing mineral according to claim 1, which is characterized in that:
in step (a-5) of water leaching the calcined primary leach residue, followed by solid-liquid separation into a secondary lithium water leachate and a secondary leach residue,
the water leaching is performed by adding the calcined primary leach residue to water, and
at a temperature of 25 to 100° C., in a solid-liquid ratio of 1/20 to 1/5, and for a reaction time of 0.5 to 12 hours.

10. The hydrometallurgical method for recovering lithium from a lithium-containing mineral according to claim 1, which is characterized in that:
step (a-5) of water leaching the calcined primary leach residue, followed by solid-liquid separation into a secondary lithium water leachate and a secondary leach residue, further comprises the step of:
(a-7) calcining the secondary leach residue,
wherein the heat-treatment temperature for the calcination reaction is 500 to 1000° C.

11. The hydrometallurgical method for recovering lithium from a lithium-containing mineral of claim 10, which is characterized in that:
step (a-7) of calcining the secondary leach residue further comprises the step of:
(a-8) water leaching the calcined secondary leach residue, followed by solid-liquid separation into a tertiary lithium water leachate and a tertiary leach residue,
wherein the water leaching is performed by adding the calcined secondary leach residue to water, and
at a temperature of 25 to 100° C., in a solid-liquid ratio of 1/20 to 1/5, and for a reaction time of 0.5 to 12 hours.

12. The hydrometallurgical method for recovering lithium from a lithium-containing mineral of claim 11, which is characterized in that:
step (a-8) of water leaching the calcined secondary leach residue, followed by solid-liquid separation into a tertiary lithium water leachate and a tertiary leach residue, further comprises the step of:
(a-9) calcining the tertiary leach residue,
wherein the heat-treatment temperature for the calcination reaction is 500 to 1000° C.

13. The hydrometallurgical method for recovering lithium from a lithium-containing mineral of claim 12, which is characterized in that:
step (a-9) of calcining the tertiary leach residue further comprises the step of:
(a-10) water leaching the calcined tertiary leach residue, followed by solid-liquid separation into a quaternary lithium water leachate and a quaternary leach residue,
wherein the water leaching is performed by adding the calcined tertiary leach residue to water, and
at a temperature of 25 to 100° C., in a solid-liquid ratio of 1/20 to 1/5, and for a reaction time of 0.5 to 12 hours.

14. A lithium aqueous solution recovered by the hydrometallurgical method for recovering lithium from the lithium-containing minerals according to claim 1.
